(19) United States
(12) Patent Application Publication
(10) Pub. No.: US 2019/0352095 A1
(43) Pub. Date: Nov. 21, 2019

(54) AUTONOMOUS OBJECT STORAGE AND RETRIEVAL TOWER

(71) Applicant: Walmart Apollo, LLC, Bentonville, AR (US)

(72) Inventors: David G. Tovey, Rogers, AR (US); Kurt William Robert Bessel, Mexico, NY (US); Boyd Dean Bryant, Bella Vista, AR (US); Robert Michael Armstrong, Rogers, AR (US)

(21) Appl. No.: 16/415,489

(22) Filed: May 17, 2019

Related U.S. Application Data
(60) Provisional application No. 62/673,270, filed on May 18, 2018.

(51) Int. Cl. B65G 1/137; B65G 45/22

(52) U.S. Cl. CPC B65G 1/1373; B65G 45/22; B65G 1/1371

(57) ABSTRACT

Described in detail herein is an autonomous object storage and retrieval tower. An end effector is coupled to a robotic crane that is configured to traverse a shaft disposed within the tower. The end effector is connectable to a first sensing mechanism configured to identify an event in the tower that is associated with one or more physical objects stored in the tower and/or a second cleaning mechanism configured to resolve an event in the tower that is associated with the one or more physical objects.

### CROSS-REFERENCE TO RELATED APPLICATIONS

This application claims priority to and benefit of U.S. Patent Application Ser. No. 62/673,270, filed on May 18, 2018, the disclosure of which is incorporated herein by reference in its entirety

### BACKGROUND

Storage and retrieval towers, also known as automated kiosks or pickup towers, are used in some retail facilities to enable customers to retrieve items from the pickup towers.

### BRIEF DESCRIPTION OF DRAWINGS

Illustrative embodiments are shown by way of example in the accompanying drawings and should not be considered as a limitation of the present disclosure:

FIG. 1 is a block diagram of an interior view of the tower in accordance with an exemplary embodiment;

FIG. 2 is a block diagram of the tower in accordance with an exemplary embodiment;

FIG. 3 is a block diagram a receptacle in accordance with an exemplary embodiment;

FIG. 4 is a block diagrams illustrating an autonomous object storage and retrieval system in accordance with an exemplary embodiment;

FIGS. 5a-5c are flowcharts illustrating an exemplary process in accordance with an exemplary embodiment; and

FIG. 6 is a block diagrams illustrating of an exemplary computing device in accordance with an exemplary embodiment.

### DETAILED DESCRIPTION

Described in detail herein are an autonomous object storage and retrieval tower and associated systems and methods. In one embodiment, an exemplary autonomous storage and retrieval tower includes a housing that contains containers. Each container, which may be a tray or other storage receptacle, can support one or more physical objects. The containers may be used for receiving physical objects to be stored by the autonomous storage and retrieval tower or for outputting physical objects from the autonomous storage and retrieval tower to a customer. The autonomous storage and retrieval tower also includes shelving units disposed within the housing. Each shelving unit can support at least one container.

The exemplary autonomous storage and retrieval tower further includes a shaft disposed within the housing and an end effector coupled to a robotic crane that is configured to traverse the shaft. In an exemplary embodiment, the end effector is connectable to at least one of a first sensing mechanism configured to identify an event in the tower that is associated with a physical object and a second cleaning mechanism configured to resolve an event in the tower that is associated with the physical object. An event may include, for example, damage to a physical object or the presence of elements, such as water, that can damage physical objects. The end effector may also be coupled to a transport apparatus (e.g. a pallet) or claw-like device suitable for picking up and transporting the physical objects within the tower.

In an embodiment, the autonomous storage and retrieval tower further includes an event identification and resolution (EIR) computing system in communication with a database and a controller. The controller is operatively coupled to the end effector and robotic crane.

In one embodiment, the first sensing mechanism is a camera and the database stores at least one image of at least one physical object stored in the autonomous storage and retrieval tower. The EIR computing system receives, from the first sensing mechanism, at least one first image of a physical object. The EIR computing system retrieves one or more stored images associated with the physical object from the database. In some embodiments, the one or more stored images may be taken when the physical object is first placed on or in a container to be stored in the autonomous storage and retrieval tower. The EIR computing system determines a difference between the at least one first image and the one or more stored images to identify an event. For example, the one or more stored images may show a square-shaped package while the at least one first image may show an irregular-shaped package due to damage to the package. In another example, the one or more stored images may show a dry package on a dry container while the at least one first image may show a wet package and/or a wet container. If the images do not match, the EIR computing system instructs the controller to control the end effector to resolve the event.

The end effector may resolve the event by using the second cleaning mechanism to clean the event, for example, by spraying down the container, drying, or vacuuming the container. In an exemplary embodiment, the second cleaning mechanism includes at least one of a storage tank with cleaning material, a spray mechanism, a vacuum, and a vacuum storage tank for cleaning a container. Alternatively, the end effector may use the transport apparatus to retrieve a container and move the container to a portal for removal and cleaning.

In some embodiments, the database stores characteristics associated with the one or more physical objects. In such an embodiment, upon identifying an event associated with a physical object, the EIR computing system queries the database for the characteristics associated with the physical object. The EIR computing system determines a method to resolve the event based on the characteristics.

In some embodiments, upon identifying an event associated with a physical object, the EIR computing system autonomously initiates a replacement order for the physical object.

In some embodiments, the autonomous storage and retrieval tower further includes at least one sensor associated with one or more containers. In such an embodiment, the EIR computing system is further configured to receive, from the sensor, a notification associated with an event identified by the sensor. The EIR computing system instructs the controller to control the end effector to resolve the event. The at least one sensor may include, for example, at least one of a moisture sensor, a humidity sensor, a UV sensor, an IR sensor, or a gas sensor.

In some embodiments, the first sensing mechanism is further configured to scan the physical objects on a predefined schedule to identify events associated with the physical objects.

In some embodiments, the robotic crane uses the transport apparatus and shaft to transport a container from a receiving opening in the tower to a shelf to store the container on the shelf or to transport the container from the shelf to a delivery opening to output one or more physical objects.

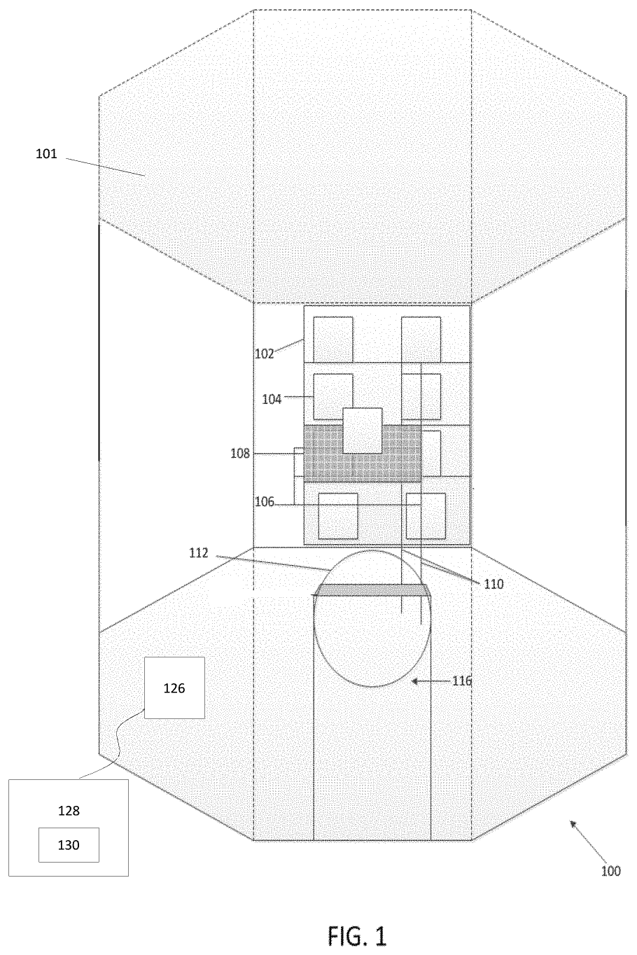

FIG. 1 is a block diagram of an interior view of an autonomous object storage and retrieval tower 100 (referred to as storage tower 100) in accordance with an exemplary embodiment. The storage tower 100 can include a housing 101. The housing 101 can include for example, eight interior walls. The interior of the storage tower 100 can include a shelving unit 102, physical objects 104 disposed in or on containers 108 on the shelving unit 102, a robotic crane 106, a boom or shaft 110, a rotating base 112, at least one receiving and/or delivery opening 116. Containers 108 may be received at the autonomous object storage and retrieval tower 100 via a variety of mechanisms such as, but not limited to, a conveyor belt delivering the containers to or through the opening 116. Containers 108 may be dispensed through the opening 116. The shelving unit 102 can include shelves configured to store and support containers holding physical objects 104. The shelving unit 102 can be disposed along one or each of the interior walls of the storage tower 100. The robotic crane 106 can extend perpendicularly from the shaft 110. The robotic crane 106 is configured to traverse the shaft 110.

In an exemplary embodiment, the storage tower 100 includes an EIR computing system 128 in communication with a database 130 and a controller 126. The controller 126 is operatively coupled to the robotic crane 106.

In exemplary embodiments, the robotic crane 106 is coupled to an end effector located at an end of the robotic crane 106. The end effector is connectable to at least one of a first sensing mechanism, such as but not limited to, an imaging device, configured to identify an event in the tower that is associated with the one or more physical objects 104. An event may be, for example, a liquid that leaked onto a container 108 from a physical object 104. The end effector is also connectable to a second cleaning mechanism configured to resolve an event in the tower that is associated with the one or more physical objects 104. The rotating base 112 can be configured to rotate the shaft 110, 360 degrees, around the interior of the storage tower 100. The shaft 110 is perpendicular to shelving unit 102 containing a physical object 104 and the robotic crane 102 can vertically move up and down the shaft 110 to align itself with the shelf on which a physical object 104 is disposed.

In one embodiment, the robotic crane 106 uses the first sensing mechanism to scan the physical objects 104 on a predefined schedule to identify events associated with the physical objects 104. For example, in one embodiment, the first sensing mechanism is a camera and the database 130 stores images of the physical objects 104. For example, the database 130 may contain an image of each physical object 104. In such an embodiment, the camera takes at least one first image of a physical object 104. The camera transmits the first image of the physical object 104 to the DR computing system 128. The DR computing system 128 retrieves the stored images associated with the physical object 104 from the database 130. The EIR computing system 128 compares the images to determine a difference between the first image and the stored image to identify an event (such as a change in the contours of the physical object 104 indicating damage to the physical object 104). The EIR computing system 128 instructs the controller 126 to control the end effector on the robotic crane 106 to resolve the event using the second cleaning mechanism.

In an exemplary embodiment, the second cleaning mechanism is a cleaning device that includes at least one of a storage tank with cleaning material, a spray mechanism, a vacuum, and a vacuum storage tank for cleaning the containers 108, and/or a transport apparatus that secures a container 108 for moving the container 108 to a portal for removal and cleaning.

In some embodiment, the database 130 stores characteristics associated with the physical objects 104. Upon identifying, an event associated with a physical object 104, the EIR computing system 128 queries the database 130 for the characteristics associated with the physical object 104. For example, the EIR computing system 128 can receive identification information associated with the physical object 104 and query the database 130 to retrieve information associated with the physical object 104. The information can include, name of physical object, type of physical object, size of physical object, the materials comprised in the physical object (the materials can be liquid, gas or air), and other information associated with the physical object. The EIR computing system 128 then determines a method to resolve the event based on the characteristics. In an exemplary embodiment, each event is associated in the database 130 with a method to resolve the event.

For example, the first sensing mechanism may identify an event associated with a physical object 104 where liquid has leaked onto a container 108. The EIR computing system 128 queries the database 130 for the characteristics associated with the physical objects 104. The DR computing system 128 may determine that based on the characteristics of the materials making up the physical object 104, physical object 104 is susceptible to leaking liquid. The EIR computing system 128 may determine a method to resolve an event involving liquid is using a vacuum to suck up the liquid from the container 108.

Alternatively, the DR computing system 128 may determine that an appropriate method to resolve an event is to retrieve the container 108 holding the physical object 104. The robotic crane 106 can navigate to the location of the container 108 within the storage tower 100, and pick-up the container 108 on which the physical object 104 is disposed. The robotic crane 106 can transport the container 108 via the delivery and/or receiving openings 116 in the tower to another location where the container 108 and/or physical object 104 can be retrieved and cleaned.

In some embodiment, upon identifying an event associated with one or more physical objects 104, the DR computing system 128 autonomously initiates a replacement order for the one or more physical objects 104 due to the nature of the event. For example, certain events may result in the physical object being unfit for sale to a customer.

In some embodiments, at least one sensor is associated with a container. In such an embodiment, the EIR computing system 128 receives a notification from the sensor. The notification includes information associated with an event identified by the sensor (for example, the sensor detects water on a particular container). The EIR computing system 128 instructs the controller 126 to control the end effector using the second mechanism to resolve the event. The at least one sensor may be, for example, a moisture sensor, a humidity sensor, a UV sensor, an IR sensor, or a gas sensor.

In some embodiments, the first sensing mechanism is further configured to scan the physical objects 104 on a predefined schedule to identify events associated with the physical objects 104.

In one embodiment, the robotic crane 106 includes a transport apparatus, such as, for example, a pallet to load and unload physical objects 104 that are on or in the containers 108 from the shelving units 102. It should also be appreciated that in other embodiments, the physical objects may be stored on the shelves but not be on or in containers 108. The robotic crane 106 can receive instructions from EIR computing system 128 and/or a separate computing system to load a physical object 104 from the shelving unit 102 (or its container), onto the robotic crane 106 and transport the physical object 104 to opening 116. The rotating base 112 can be configured to rotate the shaft 110, 360 degrees, around the interior of the storage tower 100 so that the shaft 112 is perpendicular to the appropriate shelving unit 102. The robotic crane 102 can vertically move up and down the shaft 110 to align itself with the shelf on which the physical object 104 is disposed. The transport apparatus can be used to unload a container or a product associated with an event from a shelving unit 102, to load a physical object 104 onto a shelving unit 102 for storage in the storage tower 100, or to obtain and dispense from the storage tower 100 a requested physical object 104 that has been ordered by a customer.

The transport apparatus can slide under the physical object 104 (or its container 108) and pick up the physical object 106 and/or the container 108 on which the physical object is disposed. The robotic crane 106 can move along the shaft 110 to transport and deposit the physical object 104 at the opening 116.

In some embodiments, the storage tower 100 may include a section where the robotic crane 106 can change the end effector to include the first sensing mechanism or the second cleaning mechanism. For example, the robotic crane 106 may be configured to change the end effector to include the first sensing mechanism or the second cleaning mechanism depending on the task. For example, when the robotic crane 106 is loading and unloading physical objects 104 from the shelving units 102, the end effector is coupled to the second cleaning mechanism, and more particularly the transport apparatus. When the robotic crane 106 needs to begin identifying events that are associated with the physical objects 104, the end effector is changed to be coupled to the first sensing mechanism. When the robotic crane 106 begins cleaning an event that is associated with a physical object 104, the end effector changes to be coupled to the second cleaning mechanism, for example, the spray mechanism or vacuum mechanism.

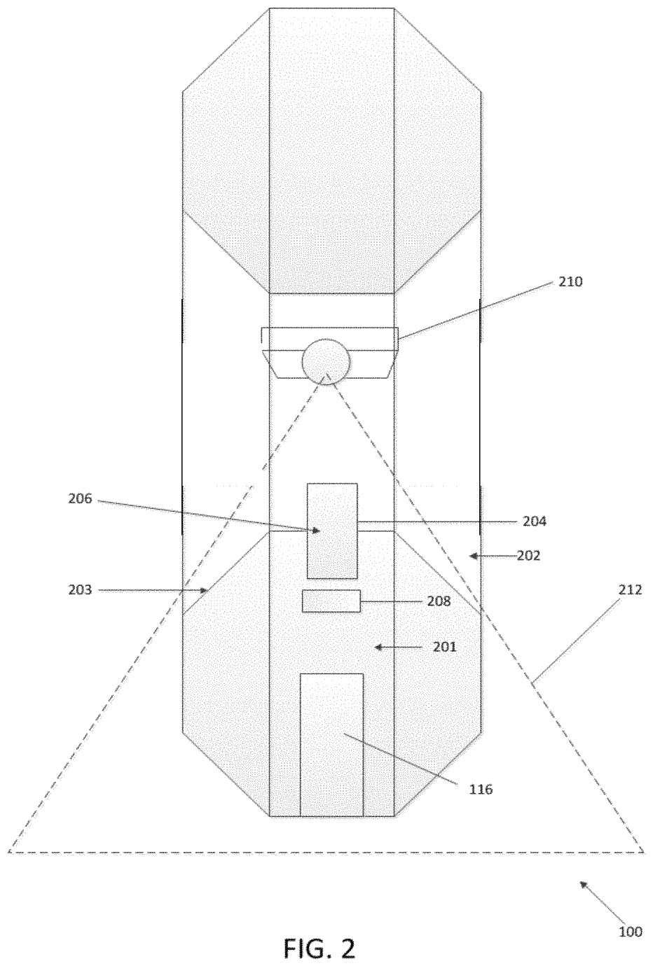

FIG. 2 is a block diagram of the outside of the storage tower in accordance with an exemplary embodiment. The storage tower 100 can be of an octagonal shape. The storage tower 100 can have eight outside surfaces including a front surface 201, a first side surface 202, and a second side surface 203. It can be appreciated the storage tower 100 can include five other surfaces (not shown). The opening 116 can be disposed on the front surface 201, the first side surface 202, and/or on the second side surface 203. It will be appreciated that the tower may have more or fewer opening than shown in FIG. 2 (for example, two or more openings 116) and that each opening 116 may be for receiving and/or delivering physical objects 104 without departing from the scope of the present invention.

An interactive display 204 can be disposed the front surface 201 of the storage tower 100. The interactive display 204 can be disposed on the front surface 201 with respect to the opening 116. An input device 208 can also be disposed on the storage tower. The input device 208 can be disposed on the front surface 201 with respect to the opening 116. The input device 208 can be one or more of, an optical scanner, a keyboard/keypad, and image-capturing device.

The interactive display 204 can render a textual or graphical user interface (GUI) 206 (referred to hereafter as GUI 206 for ease of illustration). The GUI 206 can display information associated with a request for dispensing a physical object through the opening of the storage tower. As an example, a user can input information associated with a request for dispensing a physical object. The information can be an identifier, name, username, pin number, or any other information identifying the physical object. As a non-limiting example, the user can enter the information, via a touchscreen display incorporated in the interactive display 204. Alternatively, or in addition to, the interactive display 204 can have multiple input devices such as a keyboard, mouse, joystick, touchpad, or other devices configured to interact with the interactive display 204, such as the input device 208. The user can input identification information using the input device 208.

The user can also scan a machine-readable element encoded with an identifier associated with the physical object, using the input device 208. As an example, the input device 208 can be an optical scanner or an image-capturing device. The input device 208 can scan/capture and decode the identifier from the machine-readable element. The machine-readable element can be a barcode or a QR code. The input device 208 can transmit the identifier to the interactive display. The interactive display 204 can receive the information associated with the request and transmit the information to a computing system (for example, EIR computing system 128 or a separate computing system).

In one embodiment, a motion sensor 210 can be disposed on the front surface 201 of the storage tower 100. The motion sensor 210 can detect a user approaching the storage tower 100, within a given radius 212. Doors of the opening 116 can automatically open in response to the motion sensor 210 detecting a user approaching the storage tower 100. Alternatively, or in addition to, the interactive display 204 can be powered down (in energy saving mode) and later in response to the motion sensor detecting a user entering the radius 212, the interactive display 204 can be powered on.

In one embodiment, the user can request to dispense a physical object, disposed in the storage tower 100. The user can input identification information associated with the using the interactive display 204 and/or input device 208. The identification information can be transmitted to the computing system. The computing system can instruct the storage tower 100 to retrieve and dispense the physical object and/or container from storage on one of the shelves via opening 116. The storage tower can dispense the physical object and/or its container through the opening 116 of the storage tower 100.

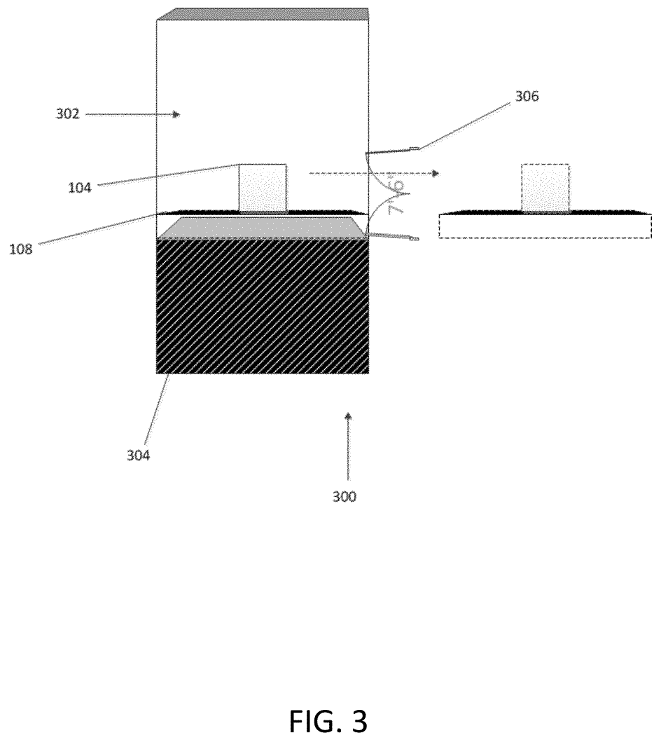

FIG. 3 is a block diagram of an interior view of opening 116 as a receptacle in accordance with an exemplary embodiment. The openings 116 can be embodied as a front, first side or second side receptacle 300. The receptacle 300 can include a volume 302 and a base 304. The opening of the receptacle 300 can include doors 306 allowing access from outside the tower. As an example, the doors 306 can be sliding doors, which can slide up and down vertically and/or horizontally. The doors 306 can provide access to the volume 302 of the receptacle 300. The physical object 104 and/or the container 108 can be deposited on the base 304 within the receptacle 300. The base 304 can be configured to couple with the physical object 104 and/or container 108. The physical object 104 and/or container can be ejected from receptacle 300 through the doors 306 of the opening, using magnetic and/or mechanical mechanisms. In one embodiment, receptacle 300 can receive a physical object 104 and/or container 108 through the doors 306.

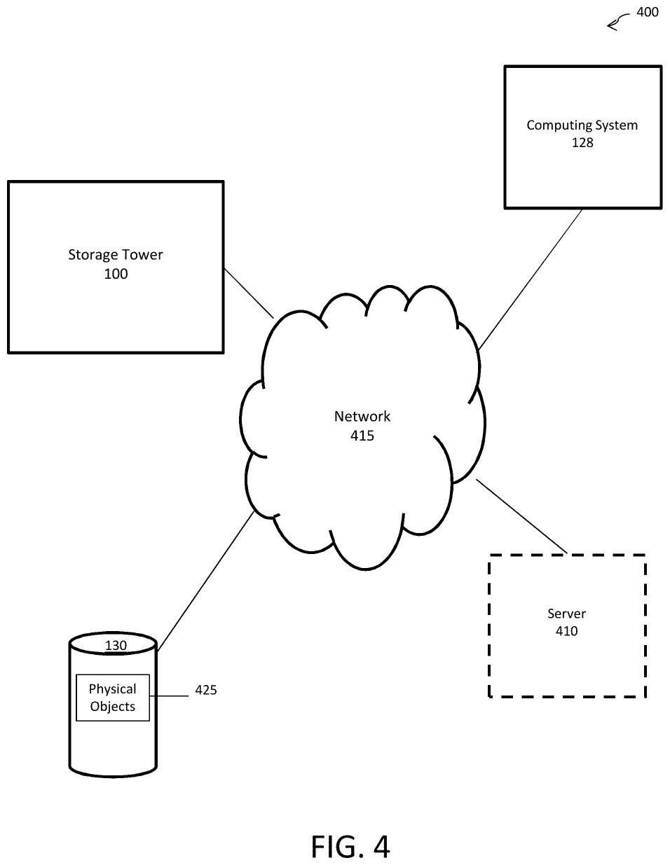

FIG. 4 illustrates an exemplary autonomous object storage and retrieval system 400 in accordance with an exemplary embodiment. The autonomous object storage and retrieval system 400 can include one or more databases 130, one or more EIR computing systems 128, and one or more storage towers 100 as described in FIGS. 1-3. Although the EIR computing system 128 is shown as located in a geographically distributed location from the storage tower 100, in alternative embodiments, the EIR computing system 128 can be located in the same geographical location as the storage tower 100, including within the storage tower 100.

In an example embodiment, one or more portions of the communications network 415 can be an ad hoc network, a mesh network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a Wi-Fi network, a WiMax network, any other type of network, or a combination of two or more such networks.

In some embodiments, the system 400 further includes one or more servers 410 that include one or more computers or processors configured to communicate with the EIR computing system 128, the databases 130, and the storage towers 100 (including the robotic cranes 106) via the communications network 415. The server 410 hosts one or more applications configured to interact with EIR computing system 128 and/or facilitates access to the content of the databases 130. The databases 130 may store information/data, as described herein. For example, the databases 130 can include a physical objects database 425. The physical objects database 425 can store information associated with physical objects disposed in the storage towers 100, such as locations within the storage tower 100 where each physical object is disposed, characteristics of each physical objects, and/or one or more images of each physical objects. The databases 130 can be located at one or more geographically distributed locations from the EIR computing system 128. Alternatively, the databases 130 can be located at the same geographically as the EIR computing system 128.

In exemplary embodiments, one or more storage towers 100 can be disposed in a facility. Physical objects can be disposed in the storage towers 100. A user can request a physical object to be dispensed at storage tower 100 and/or to be stored in the storage tower 100. The user can input identification information associated with the physical object at the interactive display 204 and/or input device 208. A processor of storage tower 100 can receive the identification information and transmit the identification information associated with the physical object to the EIR computing system 128.

The EIR computing system 128 can receive the identification information associated with the physical object and execute a routing application. The routing application can query the towers database 130 to retrieve information associated with the storage tower 100 in which the physical object is disposed and a location within the storage tower 100 where the physical object is disposed. The routing application can instruct the storage tower 100, via the processor, to dispense and/or receive the physical object. The robotic crane 106 can navigate to the location of the physical object within the storage tower 100, and pick-up the container 108 on which the physical object is disposed. Alternatively, the storage tower 100 can receive the physical object disposed on a container 108 in a receptacle 300. The robotic crane 106 can pick up the container 108 from the receptacle 300 and the robotic crane 106 can deposit the container 108 on a shelving unit within the storage tower 100.

As a non-limiting example, the autonomous storage and retrieval system 400 can be implemented in a retail store. The storage towers 100 can be disposed at the retail store. The physical object can be products purchased or about to be purchased by users from the retail store. The user can be a customer of the retail store and can pick-up products from the storage towers. As an example, the user can purchase something online and pick-up the product from the storage tower 100. Alternatively, or in addition to, the user can use an interactive display of the storage towers 100 and/or a Point-of-Sale (POS) terminal of the retail store to purchase a product and pick-up the product from the storage towers 100. The products can be made up of materials with characteristics that are susceptible to leaking from the one or more physical objects.

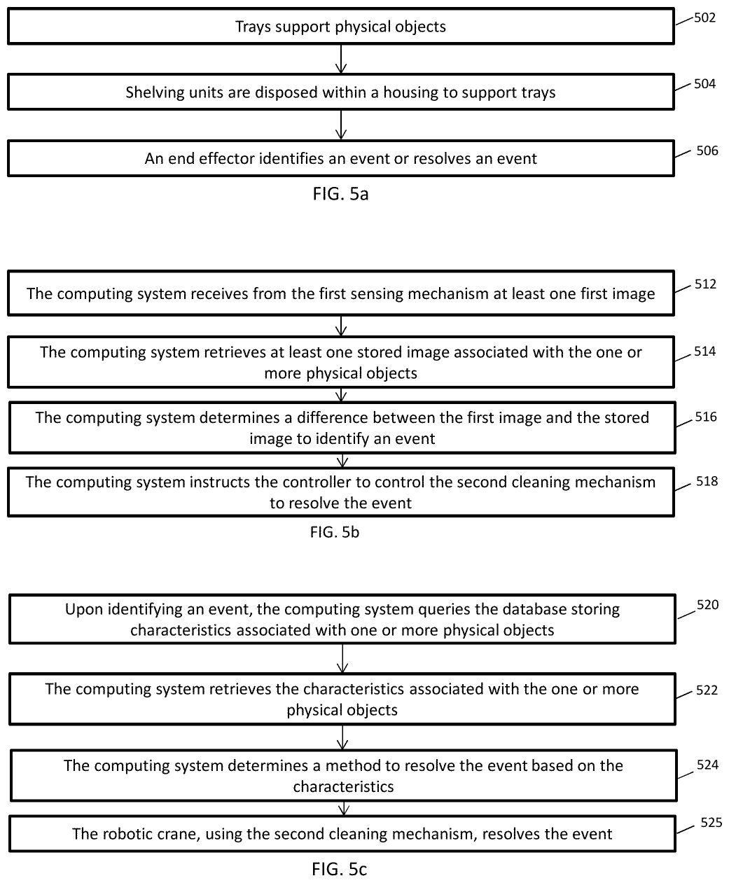

FIGS. 5a-5c are flowcharts illustrating exemplary processes performed by the autonomous storage and retrieval system according to exemplary embodiments. In an exemplary embodiment, the autonomous storage and retrieval system includes an EIR computing system configured to control a controller that controls the end effector. In FIG. 5a, at 502, containers are configured to support physical objects. At 504, shelving units are disposed within a housing to support the containers. At 506, an end effector identifies an event associated with one or more physical objects and/or resolves an event associated with the one or more physical objects. The end effector is connectable to a robotic crane that is configured to traverse a shaft disposed within the housing. The end effector is connectable to a first sensing mechanism to identify the event associated with the one or more physical objects and/or a second cleaning mechanism to resolve the event associated with the one or more physical objects.

In FIG. 5b, at 512, the EIR computing system receives from the first sensing mechanism at least one first image of a physical object, when the first sensing mechanism is a camera or other imaging device. At 514, the EIR computing system retrieves from a database one or more stored images associated with the physical object. At 516, the EIR computing system determines a difference between the first image and the stored image to identify an event. At 518, the EIR computing system instructs the controller to control the end effector using the second cleaning mechanism to resolve the event. In some embodiments, the robotic crane, using the first sensing mechanism, scans the physical objects on a predefined schedule to identify events associated with the physical objects. In another embodiment, there is at least one sensor associated with a container that identifies an event and transmits a notification to the EIR computing system. The EIR computing system then instructs the controller to control the end effector to resolve the event.

In FIG. 5c, upon identifying an event associated with a physical object, at 520, the EIR computing system queries a database storing characteristics associated with the physical object. At 522, the EIR computing system retrieves the characteristics associated with the physical object. At 524, the EIR computing system determines a method to resolve the event based on the characteristics. At 525, the robotic crane, using the second cleaning mechanism, resolves the event. The second cleaning mechanism may be a cleaning device that includes at least one of a storage tank with cleaning material, a spray mechanism, a vacuum, and a vacuum storage tank for cleaning a container, or a transport apparatus that secures a container for moving the container to a portal for removal and cleaning.

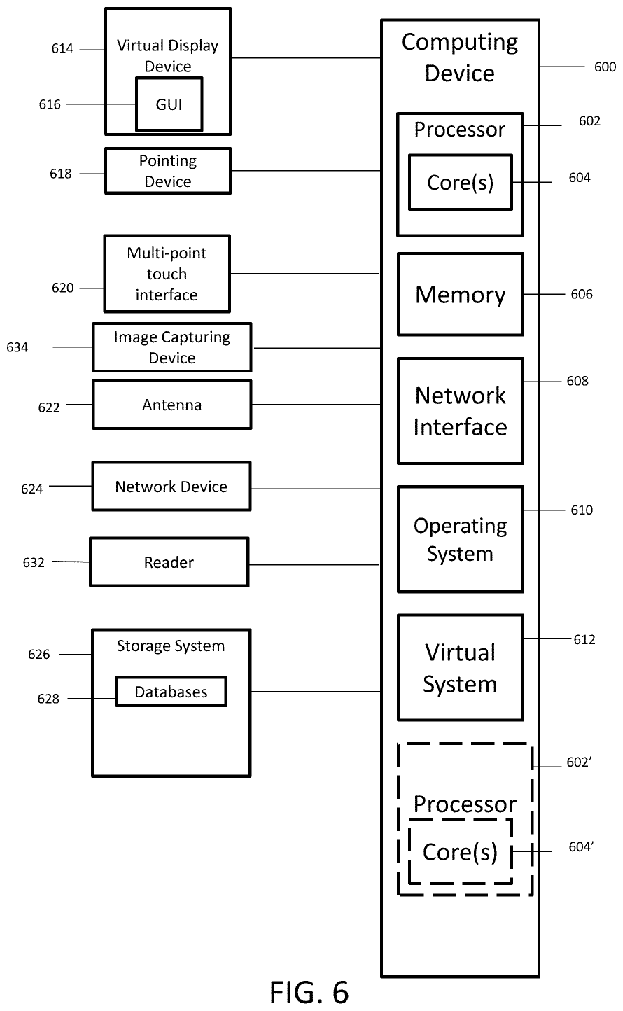

FIG. 6 is a block diagram of an example computing device 600 for implementing exemplary embodiments of the present disclosure. In an exemplary embodiment, the computing device 600 is the EIR computing system 128 described herein. The computing device 600 may be, but is not limited to, laptop, desktop computer, server, or network appliance. The computing device 600 can be embodied as part of the DR computing system 128 or the storage tower 100. The computing device 600 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 606 included in the computing device 600 may store computer-readable and computer-executable instructions or software for implementing exemplary operations of the computing device 600. The computing device 600 also includes configurable and/or programmable processor 602 and associated core(s) 604, and optionally, one or more additional configurable and/or programmable processor(s) 602′ and associated core(s) 604′ (for example, in the case of computer systems having multiple processors/cores), for executing computer-readable and computer-executable instructions or software stored in the memory 606 and other programs for implementing exemplary embodiments of the present disclosure. Processor 602 and processor(s) 602′ may each be a single core processor or multiple core (604 and 604′) processor. Either or both of processor 602 and processor(s) 602′ may be configured to execute one or more of the instructions described in connection with computing device 600.

Virtualization may be employed in the computing device 600 so that infrastructure and resources in the computing device 600 may be shared dynamically. A virtual machine 612 may be provided to handle a process running on multiple processors so that the process appears to be using only one computing resource rather than multiple computing resources. Multiple virtual machines may also be used with one processor.

Memory 606 may include a computer system memory or random access memory, such as DRAM, SRAM, EDO RAM, and the like. Memory 606 may include other types of memory as well, or combinations thereof.

A user may interact with the computing device 600 through a visual display device 614, such as a computer monitor, which may display one or more graphical user interfaces 616, multi touch interface 620, a pointing device 618, an image-capturing device 634, and a scanner 632.

The computing device 600 may also include one or more computer storage devices 626, such as a hard-drive, CD-ROM, or other computer readable media, for storing data and computer-readable instructions and/or software that implement exemplary embodiments of the present disclosure (e.g., applications). For example, exemplary storage device 626 can include one or more databases 628 for storing information regarding physical objects and the storage towers. The databases 628 may be updated manually or automatically at any suitable time to add, delete, and/or update one or more data items in the databases.

The computing device 600 can include a network interface 608 configured to interface via one or more network devices 624 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 622 to facilitate wireless communication (e.g., via the network interface) between the computing device 600 and a network and/or between the computing device 600 and other computing devices. The network interface 608 may include a built-in network adapter, network interface card, PCMCIA network card, card bus network adapter, wireless network adapter, USB network adapter, modem or any other device suitable for interfacing the computing device 600 to any type of network capable of communication and performing the operations described herein.

The computing device 600 may run any operating system 610, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or any other operating system capable of running on the computing device 600 and performing the operations described herein. In exemplary embodiments, the operating system 610 may be run in native mode or emulated mode. In an exemplary embodiment, the operating system 610 may be run on one or more cloud machine instances.

In an exemplary embodiment, one or more of the exemplary embodiments include one or more localized IoT devices and controllers that may provide some, or all, of the localized computing resources. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system may be reduced significantly. For example, whenever a localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data may include a key kernel index summary as created under nominal conditions. In an exemplary embodiment, the kernel encodes relatively recent intermittent data (“KERRI”). As a result, in an exemplary embodiment, KERRI is a continuously utilized near term source of data, but KERRI may be discarded depending upon the degree to which such KERRI has any value. In an exemplary embodiment, KERRI may not even be utilized in any form if it is determined that KERRI is transient and may be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modeled future states, which may, for example, reflect generic background data. In an exemplary embodiment, KRG incrementally sequences all future undefined cached kernels in order to filter out data that may reflect generic background data. In an exemplary embodiment, KRG incrementally sequences all future undefined cached kernals having encoded asynchronous data in order to filter out data that may reflect generic background data.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components, or method steps, those elements, components, or steps may be replaced with a single element, component, or step. Likewise, a single element, component, or step may be replaced with multiple elements, components, or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions, and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. An autonomous storage and retrieval tower, the tower comprising:
a housing;
a plurality of containers, each container configured to support one or more physical objects, the plurality of containers suitable for receiving the one or more physical objects to be stored by the autonomous storage and retrieval tower and for outputting the one or more physical objects from the autonomous storage and retrieval tower;
a plurality of shelving units disposed within the housing, wherein each shelving unit is configured to support at least one container of the plurality of containers; and
an end effector coupled to a robotic crane that is configured to traverse a shaft disposed within the housing, the end effector connectable to at least one of a first sensing mechanism configured to identify an event in the tower that is associated with the one or more physical objects and a second cleaning mechanism configured to resolve an event in the tower that is associated with the one or more physical objects.

2. The tower of claim 1, further comprising:
a controller operatively coupled to the end effector and robotic crane; and
a computing system in communication with a database and the controller.

3. The tower of claim 2, wherein the first sensing mechanism is a camera and the database stores at least one image of at least one physical object of the one or more physical objects, the computing system configured to:
receive, from the first sensing mechanism, at least one first image of the at least one physical object;
retrieve, from the database, one or more stored images associated with the at least one physical object;
determine a difference between the at least one first image and the one or more stored images to identify an event; and
instruct the controller to control the end effector and the second cleaning mechanism to resolve the event.

4. The tower of claim 2, wherein the database stores characteristics associated with the one or more physical objects, whereupon identifying an event associated with the one or more physical objects, the computing system:
queries the database for the characteristics associated with the one or more physical objects; and
determines a method to resolve the event based on the characteristics.

5. The tower of claim 2, wherein upon identifying an event associated with the one or more physical objects, the computing system autonomously initiates a replacement order for the one or more physical objects.

6. The tower of claim 2, further comprising at least one sensor associated with a container of the plurality of containers, the computing system further configured to:
receive, from the at least one sensor, a notification associated with an event identified by the at least one sensor; and
instruct the controller to control the end effector and the second mechanism to resolve the event.

7. The tower of claim 6, wherein the first sensing mechanism is further configured to scan the one or more physical objects at a predefined schedule to identify events associated with the one or more physical objects.

8. The tower of claim 6, wherein the sensor is at least one of a moisture sensor, a humidity sensor, a UV sensor, an IR sensor, or a gas sensor.

9. The tower of claim 1, where the shaft disposed within the housing also operates as a transport apparatus to transport a container of the plurality of containers from the receptacle to a shelf of the plurality of shelves to store the container on the shelf or to transport the container from the shelf to the receptacle to output the one or more physical objects.

10. The tower of claim 1, wherein the second cleaning mechanism is one of a cleaning device that includes at least one of a storage tank with cleaning material, a spray mechanism, a vacuum, and a vacuum storage tank for cleaning a container of the plurality of containers, and a transport apparatus that secures a container for moving the container to a portal for removal and cleaning.

11. An autonomous storage and retrieval method, the method comprising:
supporting, via a plurality of containers, one or more physical objects;
supporting, via a plurality of shelving units disposed within a housing, a plurality of containers;
receiving the one or more physical objects to be stored within the housing; and
at least one of identifying an event associated with the one or more physical objects or resolving an event associated with the one or more physical objects using an end effector connectable to a robotic crane configured to traverse a shaft disposed within the housing, wherein the end effector is couplable to at least one of a first sensing mechanism configured to identify the event associated with the one or more physical objects and a second cleaning mechanism configured to resolve the event associated with the one or more physical objects.

12. The method of claim 11, further comprising:
controlling, via a controller, the end effector and robotic crane; and
controlling, via a computing system in communication with a database, the controller.

13. The method of claim 12, further comprising:
receiving, by the computing system from the first sensing mechanism, at least one first image of the one or more physical objects, wherein the first sensing mechanism is a camera;
retrieving, by the computing system from the database storing at least one image of the one or more physical objects, the one or more stored images associated with the one or more physical objects;
determining, via the computing system, a difference between the at least one first image and the one or more stored images to identify an event; and
instructing, via the computing system, the controller to control the end effector and the second cleaning mechanism to resolve the event.

14. The method of claim 12, whereupon identifying an event associated with the one or more physical objects, the method further comprising:
querying, via the computing system, the database storing characteristics associated with the one or more physical objects;
retrieving, via the computing system, the characteristics associated with the one or more physical objects; and
determining, via the computing system, a method to resolve the event based on the characteristics.

15. The method of claim 12, wherein upon identifying an event associated with the one or more physical objects, the method further comprising autonomously initiating, via the computing system, a replacement order for the one or more physical objects.

16. The method of claim 12, further comprising:
receiving, by the computing system from at least one sensor associated with a container of the plurality of containers, a notification associated with an event identified by the at least one sensor; and
instructing, via the computing system, the controller to control the end effector and the second cleaning mechanism to resolve the event.

17. The method of claim 16, further comprising scanning, using the first sensing mechanism, the one or more physical objects at a predefined schedule to identify events associated with the one or more physical objects.

18. The method of claim 16, wherein the sensor is at least one of a moisture sensor, a humidity sensor, an UV sensor, an IR sensor, or a gas sensor.

19. The method of claim 11, further comprising operating the shaft as a transport apparatus to transport a container of the plurality of containers from the receptacle to a shelf of the plurality of shelves to store the container on the shelf or to transport the container from the shelf to the receptacle to output the one or more physical objects.

20. The method of claim 11, wherein the second cleaning mechanism is one of a cleaning device that includes at least one of a storage tank with cleaning material, a spray mechanism, a vacuum, and a vacuum storage tank for cleaning a container of the plurality of containers, or a transport apparatus that secures a container of the plurality of containers for moving the container to a portal for removal and cleaning.
